(19) United States
(12) Patent Application Publication
(10) Pub. No.: US 2019/0084281 A1
(43) Pub. Date: Mar. 21, 2019

(54) THERMO-INSULATING STRUCTURE

(71) Applicant: Alexander Levin, Binyamina (IL)

(72) Inventor: Alexander Levin, Binyamina (IL)

(21) Appl. No.: 15/705,331

(22) Filed: Sep. 15, 2017

(51) Int. Cl. B32B 27/10; B32B 3/28; B32B 3/04; B32B 5/02; B32B 27/30; B32B 27/32; B32B 29/08; B32B 7/02

(52) U.S. Cl. CPC B32B 27/10; B32B 3/28; B32B 3/04; B32B 5/028; B32B 27/304; B32B 27/32; B32B 2419/00; B32B 7/02; B32B 2307/304; B32B 2323/04; B32B 2327/12; B32B 2317/127; B32B 29/08

(57) ABSTRACT

An invention relates to a field of mechanical structures intended to suppress free convection in rectangular cavities and, at the same time, to diminish infrared radiation through these mechanical structures. A thermo-insulating structural unit comprises following units:
a rectangular frame constructed from two opposite transverse strips and two opposite longitudinal strips; the most part of each longitudinal strip is corrugated;
a set of first parallel lines, which are joined with the vertices of the corrugations of the opposite longitudinal strips;
a set of second parallel lines, which are joined with the valleys of the corrugations of the opposite longitudinal strips;
a flexible film, which is situated between the first and second lines in such a manner that this flexible film walks around the second parallel lines on their underside and the first parallel lines—from above.

In one embodiment the flexible film is transparent or translucent.

### STATEMENT REGARDING FEDERALLY SPONSORED RESEARCH

Not applicable.

### FIELD OF THE INVENTION

The invention relates to a field of mechanical structures intended to suppress free convection in rectangular cavities and, at the same time, to diminish infrared radiation through these mechanical structures.

### BACKGROUND OF THE INVENTION

This invention relates to an area of thermo-insulating structural units and, especially, to the thermo-insulating structural units based on application of corrugated sheets or polymer films.

Such thermo-insulating units are described in U.S. Pat. Nos. 4,035,539, 3,975,882, 3,726,408, 3,669,820, 3,445,322, 3,404,748, 3,130,112, 3,041,219, 2,417,435, 2,413,331, 2,221,309, 2,104,060, 2,101,836, 2,091,918, 2,045,733 and 1,802,522.

Application of thermo-insulating transparent (or translucent) corrugated units in solar collectors is presented in U.S. Pat. Nos. 4,126,014, 4,120,283, 4,078,544, 4,062,346, 4,046,133 and 3,951,129.

However, all these patents are based on application of rigid transparent (or translucent) polymer sheets with sufficiently high thickness for fabrication of the transparent corrugated units. It causes high cost of such transparent corrugated units and, on the other hand, high level of their optical absorption of solar radiation.

Therefore, it is reasonable to suppose that use of transparent flexible films from polymers for fabrication of such thermo-insulating corrugated units can to solve these problems.

U.S. Pat. No. 4,019,496 describes a solar-to-thermal energy converter, which comprises an insulated frame, a solar energy absorber mounted in the frame, fluid flow heat exchanger means thermally coupled to the absorber to carry away as thermal energy the absorbed solar energy, and a window transmissive to solar energy mounted in the frame and spaced from the absorber, that improvement consisting of a heat loss suppressor comprising a multiplicity of walls extending between the window and the absorber, adjacent walls being at least in part non-parallel to each other to define a first set of elongated channels generally diverging and opening toward the window interleaved with a second set of elongated channels generally diverging and opening toward the absorber, the walls being of material transmissive to solar energy and absorptive of thermal energy, the channels being narrow enough to reduce conversion heat loss and deep enough to reduce radiation heat loss.

U.S. Pat. No. 4,078,544 describes a radiant energy absorbing device, which comprises among other units first and second cover plates formed of a material which transmits radiant energy, said first cover plate being in a corrugated form including a plurality of adjacent V-shaped sections and a housing; said first cover plate is of a thin material and said housing is provided with a slotting mechanism which supports said first cover plate, said slotting mechanism providing the structural strength to support said first cover plate.

U.S. Pat. No. 4,207,869 describes a construction for minimizing convective air movement between two spaced-apart rigid panels having aligned peripheral edges that include two opposed side edges for each panel, and also for bracing the panels in spaced relation while keeping them substantially in a single, mutual, spatial orientation, the construction comprising: four longitudinal members each having an elongated slot receiving one of said four side edges, each said member defining an elongated recess in which bar elements can be received at vertically spaced intervals, the recess of each member being directed perpendicular to the slot thereof, and opening toward the opposing rigid panel, a plurality of vertically spaced bar elements along each pair of aligned side edges, each bar element spanning between the two panels and having its ends lodged in the respective elongated recesses, a flexible web having a width substantially the same as the spacing between the panels, the web being strung back and forth in tension between the bar elements and between the panels, thereby defining a plurality of adjacent chambers, and means restraining the adjacent pairs of longitudinal members against separating.

U.S. Pat. No. 4,278,721 describes a thermal barrier having a corrugated structure which eliminates convection losses and greatly reduces conduction losses. The invention relates to various methods of reducing infra-red radiation loss. The channels formed by the corrugations have a length much greater than their thickness. In one embodiment, grooves are provided in the sheet forming the corrugations. In another embodiment, an infra-red absorptive coating is applied to the sheet forming the corrugations. In the third embodiment, infra-red scattering material is disposed in the channels of the corrugated material.

The author of this patent proposes application of some plastics such as Mylar, which “are fairly good in 5 mil thicknesses”.

“Material costs can be cut by 60-80% or more if 1 to 2 mil Mylar is used for side portions 14 instead of 5 mil Mylar (the cost per pound is the same independent of film thickness).”

In addition, U.S. Pat. No. 4,120,283 should be noted. This patent describes a solar heat collector built about a new collector matrix formed from flexible sheet material, such as metallic foil. The matrix presented by the foil is folded into an accordion shape to form a series of linear channels to trap solar energy. The absorbed energy is transferred to air flowing through the channels. Proper support for the expended collector matrix is provided by taut lines stretched across a supporting frame and engaged with the folded flexible sheet. Inner and outer circulation channels are provided to permit air circulation by natural heating currents. The folded sheet and lines are constructed in kit form for expansion and support at the location of use. Transverse spacers might be included between pleats.

All these patents do not give technical solutions for construction of a stable structure intended to suppress free convection with application of a very thin flexible polymer film with thickness preferably less than 1 mil, when this polymer film is V-corrugated; it is confined within the boundaries of a parallelepiped, which has a low height with relation to its width and length.

### BRIEF SUMMARY OF THE INVENTION

This invention proposes a thermo-insulating structural unit, which is fabricated in the form of a V-corrugated polymer film. The polymer film is preferably translucent or transparent. The main idea of the invention is application of a guyed structure, which comprises following units:
a rectangular frame constructed from two opposite transverse strips and two opposite longitudinal strips; the most part of each longitudinal strip is corrugated;
a set of first parallel lines, which are joined with the vertices of the corrugations of the opposite longitudinal strips;
a set of second parallel lines, which are joined with the valleys of the corrugations of the opposite longitudinal strips;
a flexible transparent film, which is situated between the first and second lines in such a manner that this flexible film walks around the second parallel lines on their underside and the first parallel lines—from above.

The terminal edges of the flexible polymer film are joined with the opposite transverse strips.

It is possible to use two auxiliary longitudinal strips, which are applied over the parallel longitudinal strips and their terminal sections are joined with the transverse strips.

This technical solution provides rigidity to the whole corrugated structure.

The longitudinal strips of the rectangular frame can be preferably from cardboard. In the other version these longitudinal strips are fabricated from wire netting.

The first and second parallel lines constitute preferably metal wires with retroverted terminal sections; these terminal sections serve for joining with the opposite longitudinal strips.

In another version the first and second parallel lines are polymer lines, for example, from PVDF or polyethylene.

In the version of application of the wire netting strips for formation of the rectangular frame, the metal wires can be joined with this rectangular frame by welding or soldering.

The longitudinal strips' V-corrugating is performed by a pair of opposite bending press tools. Each bending press tool comprises a V-shaped punch and a V-shaped die.

However, other shapes of the punch and the die can be used; for example, they can be of trapezoidal, rectangular or sinusoidal shapes.

In such a way, the process of manufacture of the thermo-insulating structural unit consists of following operations:
Formation of a rectangular frame from two longitudinal strips and two transverse strips.
Juxtaposition of a set of first lines onto the longitudinal strips in parallel with the transverse strips and following joining the terminal sections of these lower lines with the longitudinal strips.
Juxtaposition of a flexible polymer film on the set of the first lines.
Juxtaposition of a set of second lines onto the longitudinal strips in parallel with the transverse strips and following joining the terminal sections of these second lines with the longitudinal strips; these second lines are shifted by one half of the pace (the distance between the neighboring second or first lines) regarding the first lines.
Bending the opposite longitudinal strips by two opposite pairs of the V-shaped punch and the V-shaped die with formation one V-corrugation and following displacement of the rectangular frame longitudinally by one pace accordingly to distance between the neighboring second or first lines. In doing so, the V-shaped punch and V-shaped die are positioned in such away, that the arris of the V-shaped punch and the valley of the V-shaped die are positioned above and below the second line respectively.
One transverse strip of the rectangular frame is gripped and displaced consequently by one pace in the process of formation of the corrugation structure described above and the opposite transverse strip of the rectangular frame is free.

In order to achieve higher accuracy of each longitudinal displacement of the rectangular frame in the process of corrugations' formation, the equipment may include a sensor for location of the neighboring second line position; in doing so, the value of current displacement of the rectangular frame in the longitudinal direction is correlated with the estimated location of this neighboring second line.

In such a manner the obtained guyed structure, which comprises the corrugated polymer film, can be applied for suppression of convective heat losses. At the same time this guyed structure suppresses radiation losses in infrared range of the electro-magnetic spectrum.

In order to achieve sufficient rigidity of the obtained structure it is possible to apply two auxiliary longitudinal strips, which are applied over the parallel longitudinal strips and their terminal sections are joined with the transverse strips.

In another version of this invention the obtained guyed structure is inserted into a rigid carcass with a shape, which conforms the general form of this guyed structure and the opposite transverse strips of the obtained guyed structure are joined with two opposite crossbars of the rigid carcass.

### BRIEF DESCRIPTION OF THE SEVERAL VIEWS OF THE DRAWING

FIG. 1a and FIG. 1b show a top view and a side view of a rectangular frame with a set of transverse first lines joined with longitudinal strips of the rectangular frame.

FIG. 1c and FIG. 1d show a top view and a side view of the rectangular frame with the set of the transverse first lines joined with the abovementioned longitudinal strips and a flexible polymer film, which is placed on the set of the first lines.

FIG. 1e and FIG. 1f show a top view and a side view of the rectangular frame with the set of the transverse first lines joined with the abovementioned longitudinal strips, the flexible polymer film, which is placed on the set of the transverse first lines and a set of second transverse lines arranged above the flexible polymer film.

FIG. 2a shows a side view of a structure to be corrugated before beginning the bending process.

FIG. 2b shows a side view of the structure to be corrugated upon bending with formation of corrugations with elements of equipment applied for bending process.

FIG. 2c shows a side view of the corrugated structure after completing the bending process.

FIG. 2d shows a side view of the corrugated structure provided with two auxiliary longitudinal strips.

### DESCRIPTION OF PREFERRED EMBODIMENTS

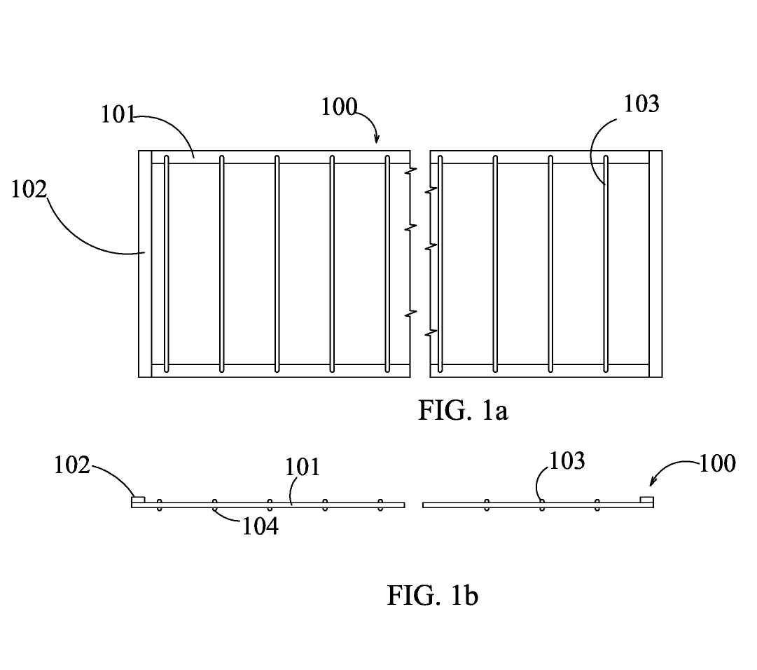

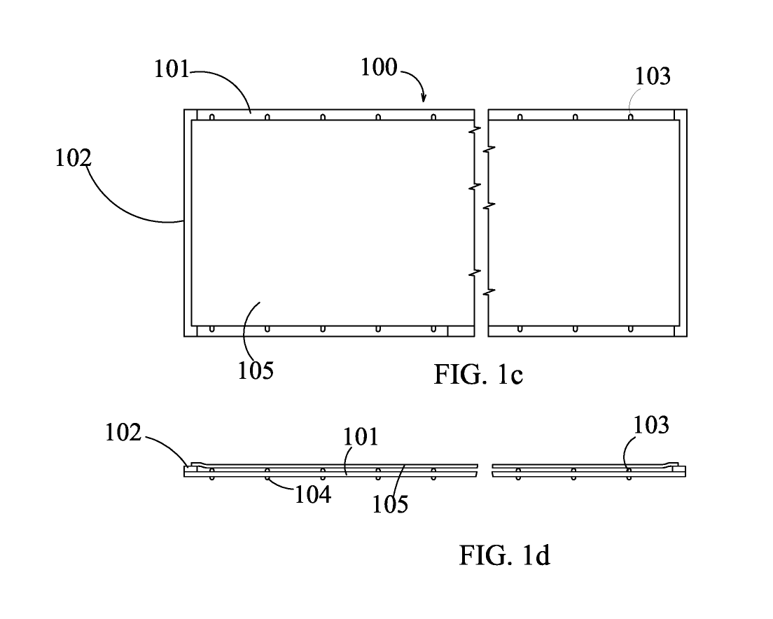

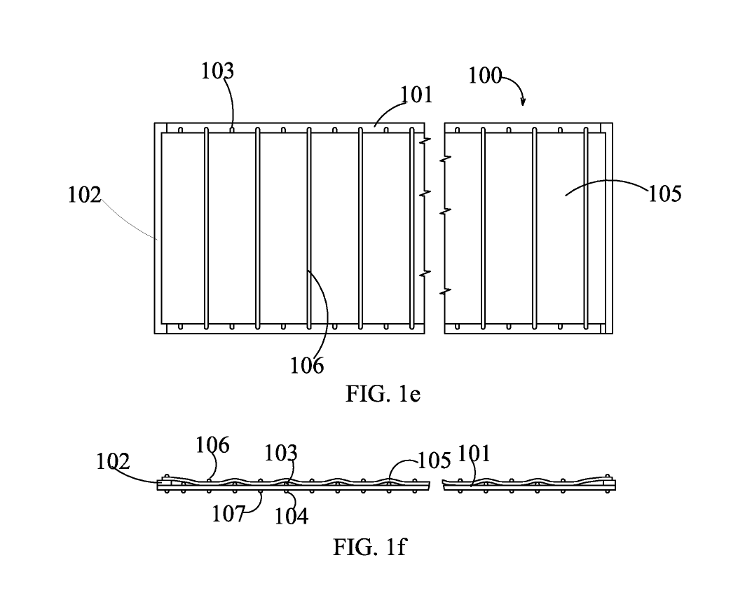

FIG. 1a and FIG. 1b show a top view and a side view of a rectangular frame 100 with a set of transverse first lines joined with longitudinal strips of the rectangular frame.

It comprises the longitudinal strips 101, transverse strips 102 and transverse first lines 103, which are joined by their retroverted terminal sections 104 with the longitudinal strips 101.

FIG. 1c and FIG. 1d show a top view and a side view of the rectangular frame 100 with the set of the transverse first lines 103 joined with the abovementioned longitudinal strips 101 and a flexible polymer film 105, which is placed on the set of the transverse first lines 103.

It comprises the longitudinal strips 101, transverse strips 102, the flexible film 105 and the retroverted terminal sections 104 of the transverse first lines 103.

FIG. 1e and FIG. 1f show a top view and a side view of the rectangular frame 100 with the set of the transverse first lines 103 joined with the longitudinal strips 101, the flexible polymer film 105 placed on the set of the transverse first lines 103 and a set of second transverse lines 106, which are arranged above the flexible polymer film 105 and joined with the longitudinal strips 101 by their retroverted terminal sections 107.

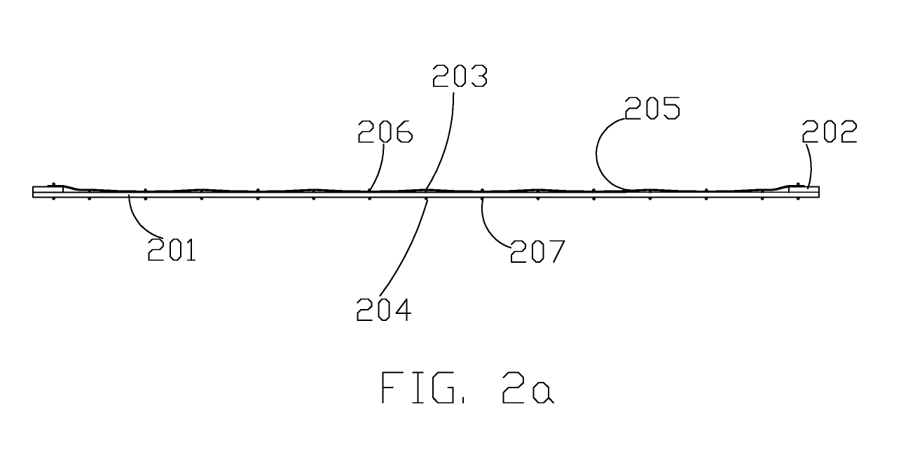

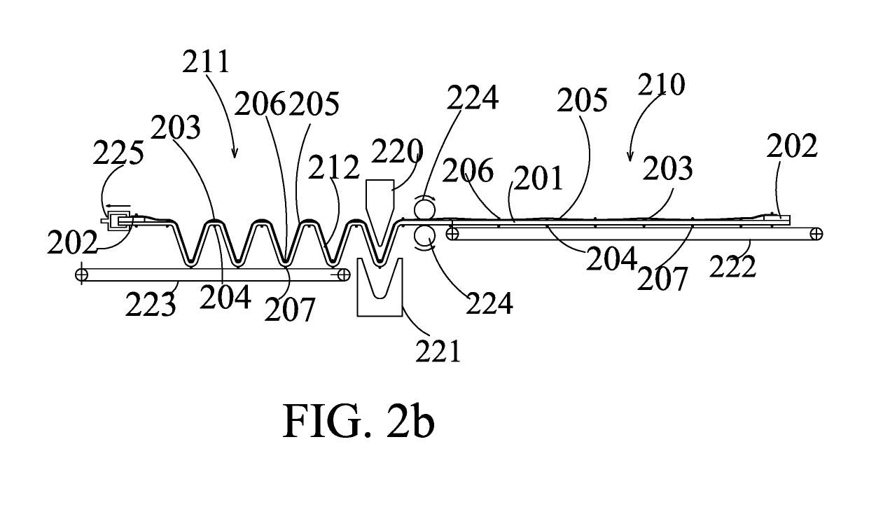

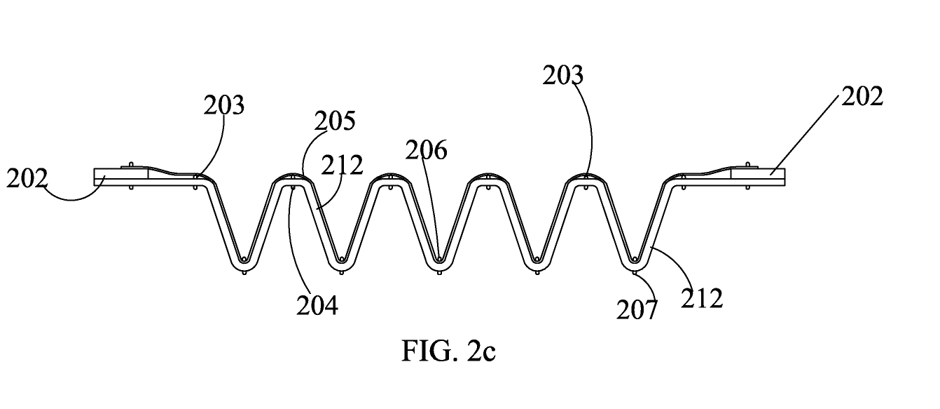

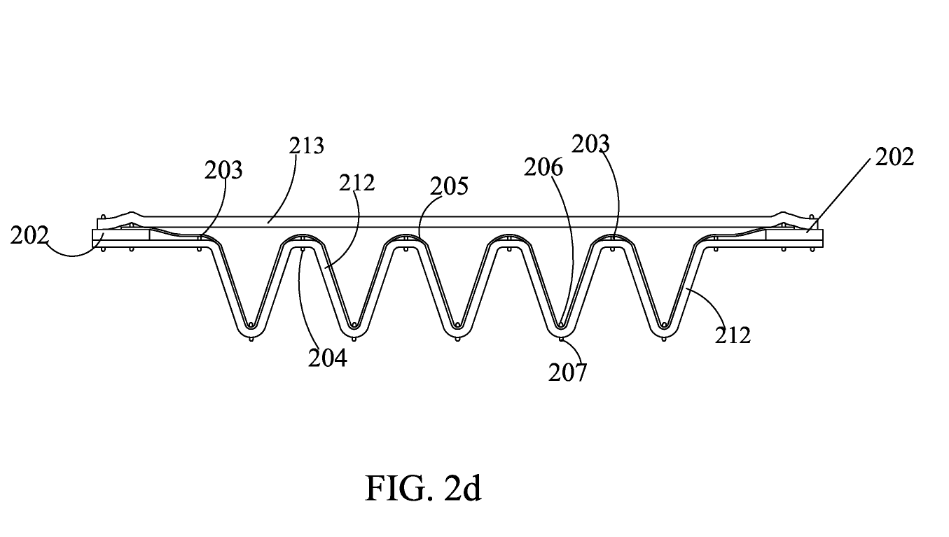

FIG. 2a shows a side view of a structure to be corrugated before beginning the bending process.

It comprises: a longitudinal strip 201, transverse strips 202, transverse first lines 203 joined with the longitudinal strip 201 by their retroverted terminal sections 204 and a set of second transverse lines 206, which are arranged above a flexible polymer film 205 and joined with the longitudinal strip 201 by their retroverted terminal sections 207.

FIG. 2b shows a side view of the structure to be corrugated upon bending with formation of corrugations with elements of equipment applied for bending process.

It comprises: the right section 210 of the longitudinal strip 201, the transverse strip 202, the transverse first lines 203 joined with the longitudinal strip 201 by their retroverted terminal sections 204 and the set of the second transverse lines 206, which are arranged above the flexible polymer film 205 and joined with the longitudinal strip 201 by their retroverted terminal sections 207.

The left section 211 of the above-mentioned structure comprises a corrugated longitudinal strip 212, the transverse strip 202, the transverse first lines 203 joined with the corrugated longitudinal strip 212 by their retroverted terminal sections 204 and the set of second transverse lines 206, which are arranged above the flexible polymer film 205 and joined with the longitudinal strip 212 by their retroverted terminal sections 207.

In addition, FIG. 2b shows punch 220, die 221, transporters 222 and 223, rollers 224 and grip 225.

These transporters 222 and 223, rollers 224 and grip 225 serve for drawing the entire structure to be corrugated through the pair punch—die forming step-by-step the corrugated thermo-insulating structure.

FIG. 2c shows a side view of the corrugated structure after completing the bending process.

It comprises: the corrugated longitudinal strip 212, the transverse strips 202, the transverse first lines 203 joined with the corrugated longitudinal strip 212 by their retroverted terminal sections 204 and the set of the second transverse lines 206, which are arranged above the flexible polymer film 205 and joined with the corrugated longitudinal strip 212 by their retroverted terminal sections 207.

FIG. 2d shows a side view of the corrugated structure provided with two auxiliary longitudinal strips.

It comprises: the corrugated longitudinal strip 212, the transverse strips 202, the transverse first lines 203 joined with the corrugated longitudinal strip 212 by their retroverted terminal sections 204 and the set of the second transverse lines 206, which are arranged above the flexible polymer film 205 and joined with the corrugated longitudinal strip 212 by their retroverted terminal sections 207, and auxiliary longitudinal strips 213.

1. A thermo-insulating structure, which is fabricated as a corrugated unit comprising:
a rectangular frame constructed from two opposite transverse strips and two opposite longitudinal strips; the most part of each said longitudinal strip is corrugated;
a set of first parallel lines, which are joined with the vertices of said corrugations of said opposite longitudinal strips;
a set of second parallel lines, which are joined with the valleys of said corrugations of said opposite longitudinal strips;
a flexible film, which is situated between said first and second lines in such a manner that said flexible film walks around said second parallel lines on their undersides and said first parallel lines—from above.

2. The thermo-insulating structure as claimed in claim 1, wherein the flexible film is transparent or translucent.

3. The thermo-insulating structure as claimed in claim 1, wherein the opposite terminal sections of the flexible polymer film are joined with the opposite transverse strips.

4. The thermo-insulating structure as claimed in claim 1, wherein the opposite longitudinal strips are fabricated from cardboard.

5. The thermo-insulating structure as claimed in claim 1, wherein the opposite longitudinal and/or opposite transverse strips are fabricated from wire netting.

6. The thermo-insulating structure as claimed in claim 1, wherein the first and second parallel lines constitute metal wires with retraverted terminal sections; said terminal sections serve for joining with the opposite longitudinal strips.

7. The thermo-insulating structure as claimed in claim 1, wherein the first and second parallel lines are polymer lines.

8. The thermo-insulating structure as claimed in claim 7, wherein the first and second parallel lines are polymer lines from PVDF or polyethylene.

9. The thermo-insulating structure as claimed in claim 1, wherein there are two auxiliary longitudinal strips, which are applied over the parallel longitudinal strips; their terminal sections are joined with the transverse strips.

10. The thermo-insulating structure as claimed in claim 1, wherein the most parts of the longitudinal strips are V-corrugated.

11. The thermo-insulating structure as claimed in claim 1, wherein the most parts of the longitudinal strips are trapezoidal-corrugated.
